(19) United States
(12) Patent Application Publication
(10) Pub. No.: US 2003/0037240 A1
(43) Pub. Date: Feb. 20, 2003

(54) System for providing authentication service of brand-name product with identification chip

(75) Inventors: Norikazu Yamagishi, Yokohama-shi (JP); Takaaki Habara, Yokohama-shi (JP); Mutsuharu Takesada, Yokohama-shi (JP); Noboru Nagasawa, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co. Ltd.

(21) Appl. No.: 10/202,191

(22) Filed: Jul. 23, 2002

(30) Foreign Application Priority Data
Aug. 14, 2001 (JP) 2001-246082

(51) Int. Cl. H04L 9/00

(52) U.S. Cl. 713/169

(57) ABSTRACT

A system 1 for providing an authentication service of a brand-name product having a micro ID chip comprises an authenticating device 2 and an ID chip management center 3 that are connected via a communication circuit 4. The authenticating device 2 reads the ID information recorded in the ID chip 6 embedded in the brand-name product. The ID chip management center 3 registers the ID number according to each brand-name product 5, and judges whether the ID number being registered matches the ID information read from the ID chip 6 of the brand-name product 5. This system enables to provide a service for authenticating the brand-name product 5 having the ID chip 6 embedded thereto.

### FIELD OF THE INVENTION

The present invention relates to a system for providing an authentication service of a brand-name product with an identification (ID) chip.

Recently in Japan, various brand-name products such as bags manufactured by famous manufacturers have become very popular among women in a wide range of age-groups. There are many occasions where consumers purchase expensive brand-name products both in Japan and in other countries.

However, the brand-name products are often very expensive, and there are many fake products in the market that are designed to look exactly like the true brand-name products. Therefore, there are growing concerns among the consumers who buy brand-name products from a store other than the manufacturer's retail store or the manufacturer's agent that they may be deceived and that the products they buy may be fake. However, it is very difficult for the consumers that purchase the brand-name products to tell by visual observation whether the products are real or fake.

### SUMMARY OF THE INVENTION

The object of the present invention is therefore to suggest a system for providing an authentication service of a brand-name product with an identification chip. The present service system comprises transmitting to an ID chip management center via a communication circuit of an authenticating device the ID information read from an ID chip embedded in the object of authentication, based on the matching authentication service request received from an authentication service covenantee. The system further comprises managing the ID number provided to every authentication object at the ID chip management center, matching the ID number with the ID information of the authentication object having the ID chip embedded thereto, and determining whether the ID number matches the information from the authentication object having the ID chip embedded thereto. The present system enables to manage the ID numbers of the authentication objects at low cost.

The system for providing an authentication service of a brand-name product with an ID chip according to the present invention comprises an authenticating device and an ID chip management center that send and receive an ID information recorded in the particle-like micro ID chip that is embedded in the object of authentication; wherein the authenticating device comprises a function for reading the ID information recorded in the ID chip embedded in the object of authentication, and the ID chip management center comprises a function for registering the ID number provided to every object of authentication, and a function for determining whether the ID number being registered matches the ID information read from the ID chip embedded in the object of authentication.

The system for providing an authentication service of a brand-name product with an ID chip further characterizes in that the ID information recorded in the ID chip includes information such as the ID number, the manufacturer of the product, the name of the product, the material of the product, the date of manufacture, and the serial number.

The present system for providing an authentication service of a brand-name product further characterizes in that the authenticating device comprises an ID chip reader, an ID number identification control unit, a communication control unit, and a display unit.

Moreover, the present system for providing an authentication service characterizes in that the authenticating device comprises a function for transmitting to the ID chip management center the ID information read from the ID chip of the authentication object using an ID chip reader.

Further, the present system for providing an authentication service characterizes in that the ID chip management center comprises a database to which the ID numbers provided to every authentication object are registered.

The present system for providing an authentication service characterizes in that the ID chip management center comprises a function for searching the ID number recorded in a database and the ID information read from the ID chip of the authentication object transmitted from said authenticating device, and to determine whether the data match or not.

The present system for providing an authentication service characterizes in that the ID chip management center comprises a function for transmitting to the authenticating device the determined result of a matching process.

The present system for providing an authentication service characterizes in that the authenticating device comprises a function for displaying on a display unit the information transmitted from the ID chip management center related to the determined result of a matching process.

Further, the present system for providing an authentication service characterizes in that the information related to the matching process indicates whether the ID number and the ID information matched.

The present system for providing an authentication service further characterizes in that the ID chip management center comprises a function for charging a fee for every request for an authentication service.

Moreover, the present system for providing an authentication service characterizes in that the ID chip management center comprises a function for making an authentication service contract with an authentication service covenantee.

Even further, the present system for providing an authentication service characterizes in that the ID chip management center comprises a function for registering the contents of an authentication service contract to the database.

### BRIEF DESCRIPTION OF THE DRAWINGS

FIG. 1 is a diagram showing the system for providing an authentication service of a brand-name product with an identification chip according to the embodiment of the present invention;

FIG. 2 is a flowchart showing the process for registering contents of a contract to the identification chip management center according to the present system for providing an authentication service of a brand-name product; and

FIG. 3 is a flowchart showing the process for identifying the brand-name product with the identification chip according to the present system for providing an authentication service of a brand-name product with an identification chip.

### DETAILED DESCRIPTION OF PREFERRED EMBODIMENTS

A preferred embodiment of the present invention will now be explained in detail with reference to the accompanied drawings.

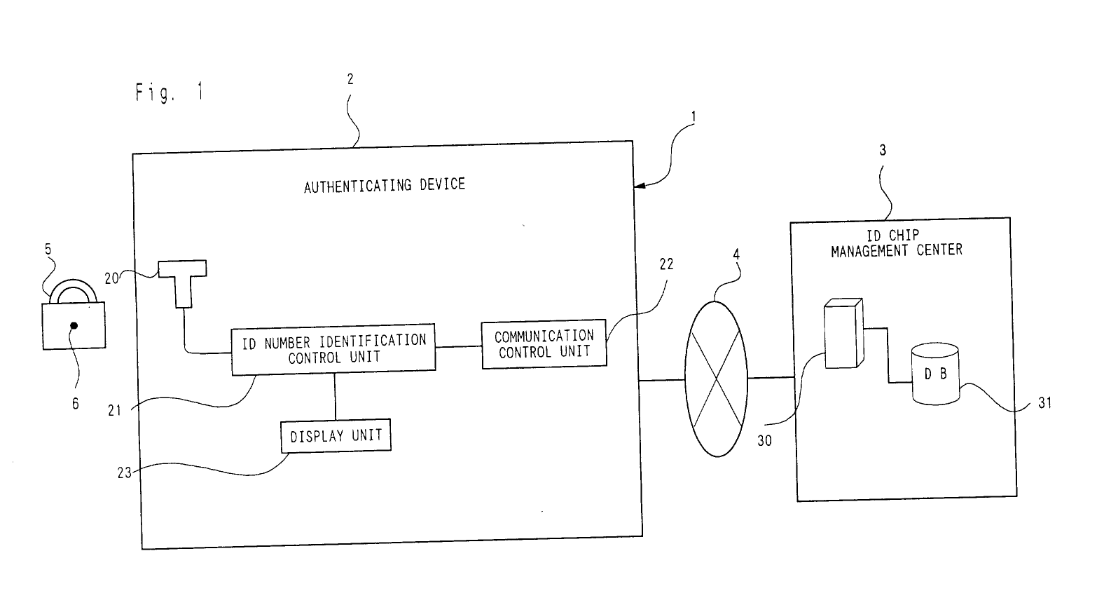

FIG. 1 is a diagram showing the system structure for providing an authentication service of a brand-name product with an identification chip according to the embodiment of the present invention.

The system 1 for providing an authentication service of a brand-name product having an identification chip according to the present invention comprises, as shown in FIG. 1, an authentication device 2 and an ID chip management center 3 that are connected via a communication circuit 4 so as to send and receive the identification (ID) information recorded to a particle-size ID chip 6 embedded to a brand-name product 5 which is the object of authentication. The authentication device 2 is equipped with a function for reading the ID information in the ID chip 6 embedded in the brand-name product 5, and the ID chip management center 3 comprises a function for registering the ID number provided to every brand-name product 5, and a function for matching and authenticating the ID number being registered with the ID information being read from the ID chip 6 embedded in the brand-name product 5.

As shown in FIG. 1, the authentication device 2 of the system 1 for providing an authentication service comprises an ID chip reader 20, an ID number identification control unit 21, a communication control unit 22, and a display unit 23.

As shown also in FIG. 1, the ID chip management center 3 of the system 1 for authenticating the brand-name product comprises a computer 30, and a database (DB) 31 that records the ID numbers provided to each brand-name product 5.

The brand-name product 5 is equipped with a particle-like ID chip 6 embedded thereto recording the ID information, as shown in FIG. 1.

According to the system 1 for providing the authentication service, the ID chip 6 records the ID information including the ID number, the name of the manufacturer of the brand-name product, the name of the product, the kind of material used in the product, the date of manufacture, the serial number, and so on.

The ID chip 6 embedded in the brand-name product 5 is formed of a very small, particle-like IC (integrated circuit) chip, and this micro IC chip is capable of recording a number comprising up to 38 digits.

The ID chip 6 has a size of 0.4 mm square with a height of 0.6 mm, that can be embedded in the brand-name product 5 and that will not break even when folded or bent. The ID chip is equipped with a 128-bit ROM (read only memory).

The system 1 for providing the authentication service comprises an authentication device 2 having an ID chip reader 20, an ID number identification control unit 21, a communication control unit 22, and a display unit 23.

The system 1 for providing the authentication service comprises in the authentication device 2 a function for transmitting the ID information that the ID chip reader read from the ID chip 6 of the brand-name product 5 to the ID chip management center 3.

According to the present system 1 for providing the authentication service, the ID chip management center 3 comprises a database 31 recording the ID number provided to each brand-name product 5.

The authenticating system 1 according to the present invention also comprises a function for searching the ID number registered to the database 31 of the ID chip management center 3 and the ID information read from the ID chip 6 of the brand-name product 5 having been transmitted to the center 3 from the authenticating device 2, and to determine whether they match.

The authenticating system 1 according to the present invention comprises a function for transmitting the result of the matching process from the ID chip management center to the authenticating device 2.

The authenticating system 1 according to the present invention further comprises a function for displaying on a display unit 23 the result of the matching process transmitted from the ID chip management center 3 to the authenticating device 2 when necessary.

The information related to the result of the matching process includes whether the ID numbers matched or not.

The authenticating system 1 according to the present invention further comprises a function for charging from the ID chip management center 3 a fee for every authentication request received.

The authenticating system 1 according to the present invention further comprises a function for making an authentication service contract at the ID chip management center 3 with the authentication service covenantee.

The authenticating system 1 according to the present invention further comprises a function for recording to the database 31 the contents of the authentication service contract at the ID chip management center 3.

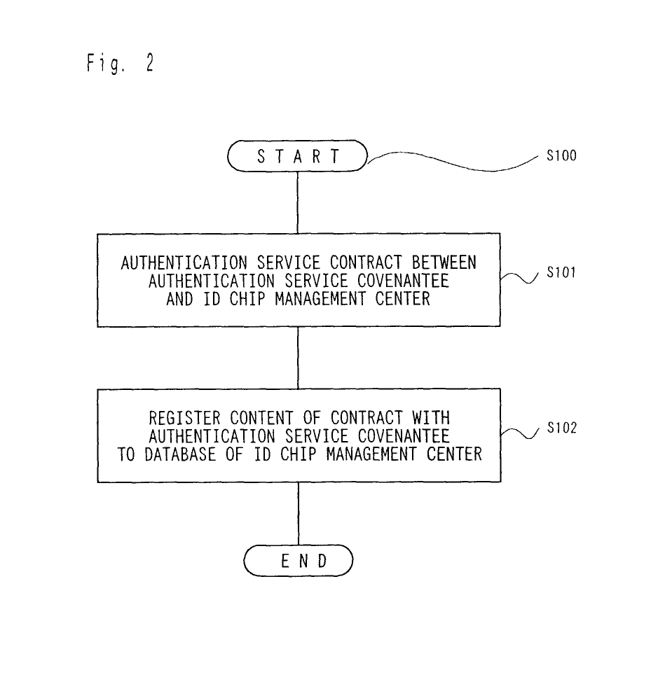

FIG. 2 is a flowchart showing the function of registering the contract contents at the ID chip management center according to the present system for providing the authentication service of the brand-name product with the ID chip.

According to the process that starts at S100, when registering the contract contents at the ID chip management center 3, a contract is made in step S101 between the authentication service covenantee and the ID chip management center 3 related to the service for authenticating the brand-name product 5 having the ID chip 6 embedded thereto. Then, in step S102, the contents of the contract related to the service for authenticating the authenticity of the brand-name product 5 having the ID chip 6 embedded thereto is recorded to the database 31 of the ID chip management center 3.

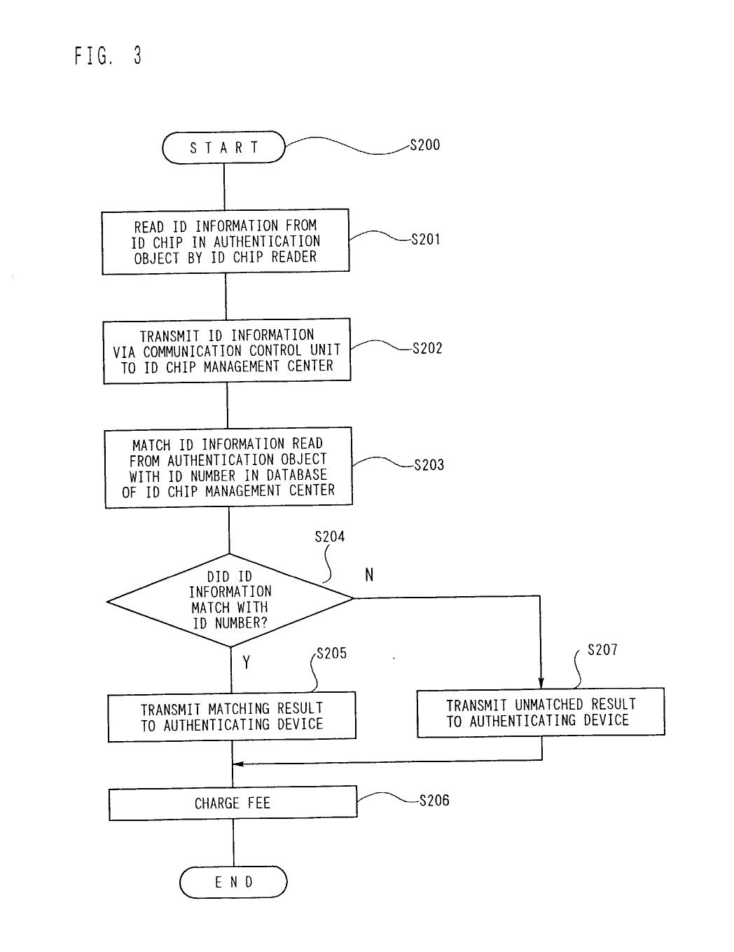

FIG. 3 is a process flowchart showing the steps for providing the service for authenticating the brand-name product with the ID chip according to the present invention.

The process of the authenticating service starts at step S200, and in step S201, the ID information recorded to the ID chip 6 embedded to the brand-name product 5 (the object of authentication) is read by the ID chip reader 20 of the authenticating device 2. Next in step S202, the ID information read from the ID chip 6 embedded to the brand-name product 5 using the ID chip reader 20 is transmitted via the communication control unit 22 of the authenticating device 2 to the ID chip management center 3. Then, in step S203, the ID number included in the ID information read from the ID chip 6 of the product 5 and transmitted from the authenticating device 2 is compared and matched with the ID number provided to each brand-name product 5 and recorded to the database 31 of the ID chip management center 3. Next, in step S204, it is determined whether or not the ID number of the ID information read from the ID chip 6 of the brand-name product 5 matches the ID number provided to each brand-name product 5.

When in step S204 the ID number of the ID information read from the ID chip 6 of the brand-name product 5 matches the ID number provided to that brand-name product 5, the result of the matching process showing that the numbers matched is transmitted to the authenticating device 2 from the ID chip management center 3 instep S205. Then, in step S206, the ID chip management center 3 charges a fee to the authentication service covenantee according to the number of authentication services being requested.

When in step S204 the ID number of the ID information read from the ID chip 6 of the brand-name product 5 does not match the ID number provided to the product 5, the procedure advances to step S207, where the ID chip management center 3 transmits the unmatched authentication result to the authenticating device 2. Then, in step S206 the ID chip management center 3 charges a fee to the authentication service covenantee according to the number of authentication services being requested.

As explained, according to the present system for providing an authentication service of a brand-name product with an ID chip, the system includes an authenticating device that comprises a function for reading the ID information recorded in the particle-like micro ID chip embedded in the object of authentication, so the ID information in the ID chip embedded in the authentication object can be transmitted via a communication circuit of the authentication device to the ID chip management center based on the request for an authentication service received from a service covenantee. Further, since the ID chip management center comprises a function for recording the ID number provided to every object of authentication, and a function for determining whether the ID number being registered matches the ID information read from the ID chip embedded in the object of authentication, the ID number provided to every authentication object can be managed at the ID chip management center so as to match and determine the authenticity of the object in which the ID chip is embedded. The present system enables to provide a service for authenticating the object in which the ID chip is embedded, and to manage the ID numbers of authentication objects at a relatively low cost.

According to the system for providing the authentication service of a brand-name product with an ID chip of the present invention, the ID information recorded in the ID chip includes information such as the ID number, the manufacturer of the product, the name of the product, the material of the product, the date of manufacture, and the serial number, so the ID information can be used for determining the authentication of the object.

According to the present system for providing the authentication service, the authenticating device comprises an ID chip reader, an ID number identification control unit, a communication control unit, and a display unit, so the ID information recorded in the ID chip embedded in the object can be read using the ID chip reader of the authenticating device. The ID number included in the ID information recorded in the ID chip is identified by the ID number identification control unit of the authenticating device, and the ID number in the ID information of the ID chip is transmitted by the communication control unit to the ID chip management center, and the information related to the result of authentication at the ID chip management center can be displayed on the display unit of the authenticating device.

According to the present system for providing the authentication service of a brand-name product with an ID chip, the authenticating device comprises a function for transmitting to the ID chip management center the ID information read from the ID chip of the authenticating object using the ID chip reader.

According further to the present system, the ID chip management center comprises a database that records the ID numbers provided to every authentication object.

According even further to the present system, the ID number recorded in a database and the ID information read from the ID chip of the authentication object transmitted from said authenticating device can be searched in order to perform a matching process.

According further to the present system, the determined result of the matching process can be transmitted from the ID chip management center to the authenticating device.

According to the present system, the information transmitted from the ID chip management center related to the result of the matching process can be displayed on the display unit according to need.

According further to the present system, the information related to the matching process shows whether or not the ID number matched the ID information, and the result of the matching process can therefore be notified to the authentication service covenantee.

According further to the present system, the fee for every request for the authentication service can be charged to the authentication service covenantee from the ID chip management center.

According further to the present system, the ID chip management center is capable of making an authentication service contract with the authentication service covenantee related to authenticating a brand-name product with the ID chip.

Finally, according to the present system, the contents of the authentication service contract made with the authentication service covenantee related to the authentication of the object having the ID chip embedded thereto can be registered to the database of the ID chip management center.

We claim:

1. A system for providing an authentication service of a brand-name product with an ID chip comprises an authenticating device and an ID chip management center that send and receive via a communication circuit an ID information recorded in the particle-shaped micro ID chip that is embedded in the object of authentication; wherein
said authenticating device comprises a function for reading said ID information recorded in said ID chip embedded in said object of authentication, and said ID chip management center comprises a function for registering the ID number provided to every object of authentication, and a function for performing a matching process determining whether the ID number being registered matches the ID information read from the ID chip embedded in said object of authentication.

2. A system for providing an authentication service of a brand-name product with an ID chip according to claim 1, wherein said ID information recorded in the ID chip includes information such as the ID number, the manufacturer of the product, the name of the product, the material of the product, the date of manufacture, and the serial number.

3. A system for providing an authentication service of a brand-name product with an ID chip according to claim 1, wherein said authenticating device comprises an ID chip reader, an ID number identification control unit, a communication control unit, and a display unit.

4. A system for providing an authentication service of a brand-name product with an ID chip according to claim 1, wherein said authenticating device comprises a function for transmitting to said ID chip management center the ID information read from the ID chip of the authentication object using an ID chip reader.

5. A system for providing an authentication service of a brand-name product with an ID chip according to claim 1, wherein said ID chip management center comprises a database to which the ID numbers provided to every authentication object are recorded.

6. A system for providing an authentication service of a brand-name product with an ID chip according to claim 1, wherein said ID chip management center comprises a function for searching the ID number recorded in a database and the ID information read from the ID chip of the authentication object transmitted from said authenticating device, and to perform the matching process.

7. A system for providing an authentication service of a brand-name product with an ID chip according to claim 1, wherein said ID chip management center comprises a function for transmitting to said authenticating device the determined result of the matching process.

8. A system for providing an authentication service of a brand-name product with an ID chip according to claim 1, wherein said authenticating device comprises a function for displaying on a display unit the information transmitted from said ID chip management center related to the determined result of the matching process.

9. A system for providing an authentication service of a brand-name product with an ID chip according to claim 1, wherein the information related to a matching process shows whether the ID number and the ID information match or not.

10. A system for providing an authentication service of a brand-name product with an ID chip according to claim 1, wherein said ID chip management center comprises a function for charging a fee for every authentication service request.

11. A system for providing an authentication service of a brand-name product with an ID chip according to claim 1, wherein said ID chip management center comprises a function for making an authentication service contract with an authentication service covenantee.

12. A system for providing an authentication service of a brand-name product with an ID chip according to claim 1, wherein said ID chip management center comprises a function for registering the contents of an authentication service contract to the database.
